(19) United States
(12) Patent Application Publication
(10) Pub. No.: US 2024/0303014 A1
(43) Pub. Date: Sep. 12, 2024

(54) IMAGE FORMING APPARATUS, INFORMATION PROCESSING METHOD, AND INFORMATION PROCESSING SYSTEM

(71) Applicant: Takehito KUROKO, Tokyo (JP)

(72) Inventor: Takehito KUROKO, Tokyo (JP)

(21) Appl. No.: 18/597,978

(22) Filed: Mar. 7, 2024

(30) Foreign Application Priority Data
Mar. 9, 2023 (JP) 2023-036947
Sep. 1, 2023 (JP) 2023-142064

(51) Int. Cl. G06F 3/12; H04N 1/00

(52) U.S. Cl. CPC G06F 3/1238; G06F 3/1222; H04N 1/00344

(57) ABSTRACT

An image forming apparatus includes circuitry. The circuitry performs an authentication process in response to a request from a first information terminal of a first administrator to log in to the apparatus. The circuitry receives designation of a device management operation from the first information terminal when the first administrator logs in. The circuitry transmits a request to log in, to second information terminals of one or more second administrators, in response to the designation. The circuitry receives the operation when at least one second administrator logs in. The circuitry transmits a request to permit execution of the operation to the second information terminal of the second administrator who has logged in, in response to the operation. The circuitry executes a process corresponding to the device management operation when at least one second administrator permits the execution of the device management operation and no second administrator rejects the execution.

### CROSS-REFERENCE TO RELATED APPLICATIONS

This patent application is based on and claims priority pursuant to 35 U.S.C. § 119(a) to Japanese Patent Application Nos. 2023-036947, filed on Mar. 9, 2023, and 2023-142064, filed on Sep. 1, 2023, in the Japan Patent Office, the entire disclosure of each of which is hereby incorporated by reference herein.

### BACKGROUND

### Technical Field

Embodiments of the present disclosure relate to an image forming apparatus, an information processing method, and an information processing system.

### Related Art

Some techniques for image forming apparatuses have been proposed that prevent unauthorized access by a person who pretends to be an administrator from the viewpoint of security.

As such a technique considering security, a technique has been proposed that determines whether to execute an operation to output image data based on the authentication of an operator who outputs the image data and the approval of a checker who checks the operation performed by the operator, to prevent information leakage and erroneous transmission by facsimile machine.

### SUMMARY

According to an embodiment of the present disclosure, an image forming apparatus includes circuitry. The circuitry performs an authentication process in response to a request from a first information terminal of a first administrator to log in to the image forming apparatus. The circuitry receives designation of a device management operation from the first administrator through the first information terminal when the first administrator logs in based on the authentication process. The circuitry transmits a request to log in to the image forming apparatus, to second information terminals of one or more second administrators different from the first administrator, in response to the designation of the device management operation. The circuitry receives the device management operation from the first administrator through the first information terminal when at least one second administrator logs in. The circuitry transmits a request to permit execution of the device management operation to the second information terminal of the at least one second administrator who has logged in to the image forming apparatus, in response to the device management operation. The circuitry executes a process corresponding to the device management operation when at least one of the at least one second administrator permits the execution of the device management operation and no one of the at least one second administrator rejects the execution of the device management operation.

According to an embodiment of the present disclosure, an information processing method performed by an image forming apparatus includes performing an authentication process in response to a request from a first information terminal of a first administrator to log in to the image forming apparatus; receiving designation of a device management operation from the first administrator through the first information terminal when the first administrator logs in based on the authentication process; transmitting a request to log in to the image forming apparatus to second information terminals of one or more second administrators different from the first administrator, in response to the designation of the device management operation; receiving the device management operation from the first administrator through the first information terminal when at least one second administrator logs in; transmitting a request to permit execution of the device management operation to the second information terminal of the at least one second administrator who has logged in to the image forming apparatus, in response to the device management operation; and executing a process corresponding to the device management operation when at least one of the at least one second administrator permits the execution of the device management operation and no one of the at least one second administrator rejects the execution of the device management operation.

According to an embodiment of the present disclosure, an information processing system includes an image forming apparatus, a first information terminal used by a first administrator, and second information terminals used by one or more second administrators different from the first administrator. The image forming apparatus includes circuitry. The circuitry performs an authentication process in response to a request from the first information terminal of the first administrator to log in to the image forming apparatus. The circuitry receives designation of a device management operation from the first administrator through the first information terminal when the first administrator logs in based on the authentication process. The circuitry transmits a request to log in to the image forming apparatus, to the second information terminals of the one or more second administrators, in response to the designation of the device management operation. The circuitry receives the device management operation from the first administrator through the first information terminal when at least one second administrator logs in. The circuitry transmits a request to permit execution of the device management operation to the second information terminal of the at least one second administrator who has logged in to the image forming apparatus, in response to the device management operation. The circuitry executes a process corresponding to the device management operation when at least one of the at least one second administrator permits the execution of the device management operation and no one of the at least one second administrator rejects the execution of the device management operation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of an information processing system according to an embodiment of the present disclosure;

FIG. 2 is a block diagram illustrating a hardware configuration of an image forming apparatus according to an embodiment of the present disclosure;

FIG. 3 is a block diagram illustrating a functional configuration of an image inspecting apparatus according to an embodiment of the present disclosure;

FIG. 4 is a flowchart of a process for enabling a special device management operation on an image forming apparatus according to an embodiment of the present disclosure;

FIG. 5 is a flowchart of a process for executing a special device management operation on an image forming apparatus according to an embodiment of the present disclosure;

FIG. 6 is a sequence diagram illustrating a process for enabling a special device management operation on an image forming apparatus according to an embodiment of the present disclosure;

FIG. 7 is a sequence diagram illustrating a process for executing a special device management operation on an image forming apparatus according to an embodiment of the present disclosure; and

FIG. 8 is a sequence diagram illustrating a process for executing a typical device management operation on an image forming apparatus according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring to the drawings, embodiments of the present disclosure are described below.

As used herein, the singular forms “a,” “an,” and “the” are intended to include the plural forms as well, unless the context clearly indicates otherwise.

For the sake of simplicity, like reference signs denote like elements such as parts and materials having the same functions, and redundant descriptions thereof are omitted unless otherwise required.

As used herein, the term “connected/coupled” includes both direct connections and connections in which there are one or more intermediate connecting elements.

### Overall Configuration of Information Processing System

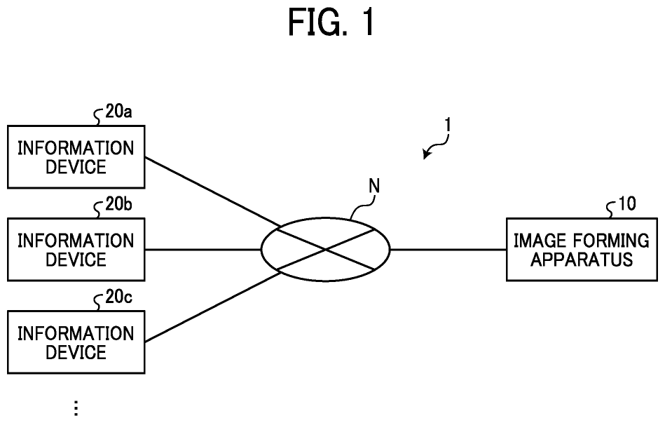

FIG. 1 is a schematic diagram of an information processing system according to an embodiment of the present disclosure.

Referring to FIG. 1, a description is given below of the overall configuration of an information processing system 1 according to the present embodiment.

The information processing system 1 illustrated in FIG. 1 enables the execution of processes on the image forming apparatus 10 through a network N in response to operations from external information devices such as information devices 20a to 20c. The network N is a network such as a local area network (LAN) or the Internet. The network N may include a wired network or a wireless network. As illustrated in FIG. 1, the information processing system 1 includes the image forming apparatus 10 and the information devices 20a to 20c.

The image forming apparatus 10 is an apparatus that executes various processes such as image formation in response to operations of the external information devices 20a to 20c. The image forming apparatus 10 is, for example, a multifunction peripheral (MFP) or a commercial printer. The MFP is an image forming apparatus having at least two functions of a copier function, a printer function, a scanner function, and a facsimile function.

The information devices 20a to 20c are information processing devices for accessing the image forming apparatus 10 in response to an operation of an administrator and performing various operations on the image forming apparatus 10. The various operations may be referred to as device management operations in the following description. The information devices 20a to 20c are, for example, personal computers (PCs), smartphones, or tablet terminals. The information devices 20a to 20c access the image forming apparatus 10 with installed native applications or web browsers. Although FIG. 1 illustrates the three information devices 20a to 20c, the number of information devices is not limited to three and may be two, four, or more. In the following description, when any one of the information devices 20a to 20c is referred to, the any one of the information devices 20a to 20c may be referred to simply as the “information device 20.” When the information devices 20a to 20c are collectively referred to, the information devices 20a to 20c may be referred to simply as the “information devices 20.”

### Hardware Configuration of Image Forming Apparatus

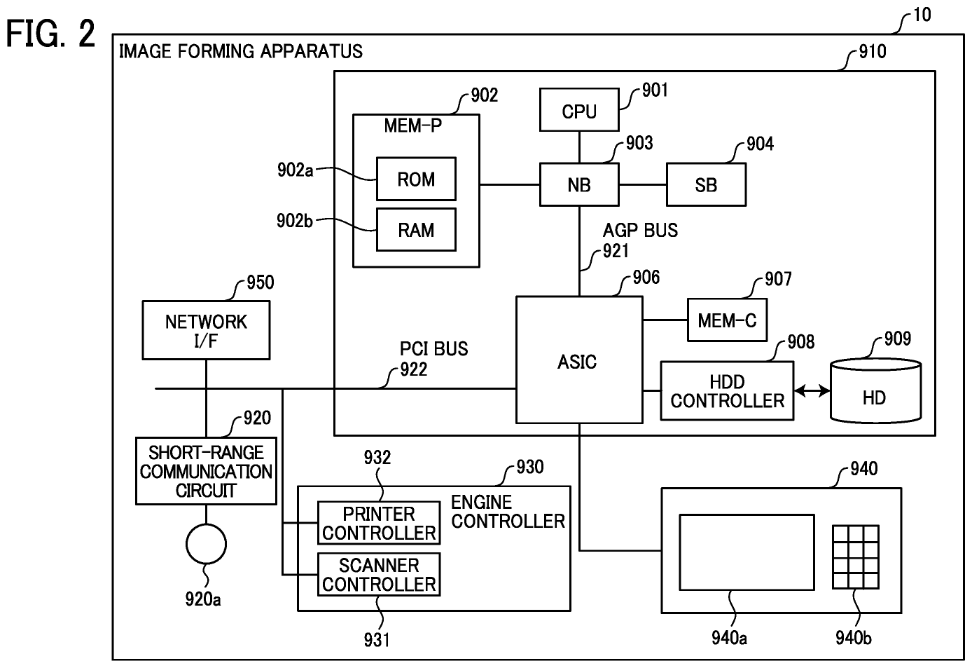

FIG. 2 is a block diagram illustrating a hardware configuration of the image forming apparatus 10 according to the present embodiment.

Referring to FIG. 2, a description is given of a hardware configuration of the image forming apparatus 10 according to the present embodiment.

FIG. 2 illustrates the image forming apparatus 10 as an MFP.

As illustrated in FIG. 2, the image forming apparatus 10 includes a controller 910, a short-range communication circuit 920, an engine controller 930, a control panel 940, and a network interface (I/F) 950.

The controller 910 includes a central processing unit (CPU) 901 as a main processor of a computer, a system memory (MEM-P) 902, a north bridge (NB) 903, a south bridge (SB) 904, an application-specific integrated circuit (ASIC) 906, a local memory (MEM-C) 907, a hard disk drive (HDD) controller 908, and a hard drive (HD) 909. The NB 903 and the ASIC 906 are connected through an accelerated graphics port (AGP) bus 921.

The CPU 901 is a processor that controls the entire operation of the image forming apparatus 10. The NB 903 connects the CPU 901 to the MEM-P 902, the SB 904, and the AGP bus 921. The NB 903 includes a peripheral component interconnect (PCI) master, an AGP target, and a memory controller that controls the reading and writing of data from and to the MEM-P 902.

The MEM-P 902 includes a read-only memory (ROM) 902a and a random-access memory (RAM) 902b. The ROM 902a stores data and programs for implementing various functions of the controller 910. The RAM 902b is used to load the programs and the data. For example, the RAM 902b is used as a drawing memory to store drawing data for printing. The programs that are stored in the RAM 902b may be stored in a computer-readable recording medium in an installable or executable file format so that the programs can be provided. Examples of the computer-readable recording medium include, but are not limited to, a compact disc read-only memory (CD-ROM), a compact disc-recordable (CD-R), and a digital versatile disc (DVD).

The SB 904 connects the NB 903 to, for example, a PCI device and a peripheral device. The ASIC 906 is an integrated circuit (IC) dedicated to image processing and includes hardware elements for image processing. The ASIC 906 serves as a bridge to connect the AGP bus 921, a PCI bus 922, the HDD controller 908, and the MEM-C 907 to each other. The ASIC 906 includes a PCI target, an AGP master, an arbiter (ARB) as a central processor of the ASIC 906, a memory controller that controls the MEM-C 907, a plurality of direct memory access controllers (DMACs), and a PCI unit. For example, the DMACs convert coordinates of image data with a hardware logic to rotate an image based on the image data. The PCI unit transfers data between a scanner controller 931 and a printer controller 932 through the PCI bus 922. The ASIC 906 may be connected to a universal serial bus (USB) interface or the Institute of Electrical and Electronics Engineers 1394 (IEEE1394) interface.

The MEM-C 907 is a local memory that is used as a buffer for image data to be copied or a code buffer. The HDD controller 908 controls the reading and writing of data from and to the HD 909 under the control of the CPU 901. The HD 909 is a storage device that accumulates image data, font data for printing, and form data. The HDD controller 908 and the HD 909 may be a solid state drive (SSD) controller and an SSD, respectively.

The AGP bus 921 is a bus interface for a graphics accelerator card, which is proposed to accelerate graphics processing. Direct access to the MEM-P 902 by high throughput can accelerate the graphics accelerator card.

The short-range communication circuit 920 is a communication circuit in compliance with a protocol such as near field communication (NFC) or BLUETOOTH. The short-range communication circuit 920 is electrically connected to the ASIC 906 through the PCI bus 922. An antenna 920a for wireless communication is connected to the short-range communication circuit 920.

The engine controller 930 includes the scanner controller 931 and the printer controller 932. Each of the scanner controller 931 and the printer controller 932 performs image processing such as error diffusion or gamma conversion.

The control panel 940 includes a panel display 940a and a hard key 940b. The panel display 940a is, for example, a touch panel that displays current settings or a selection screen and receives a user input. The hard key 940b includes, for example, a numeric keypad and a start key. The numeric keypad receives assigned values of image forming parameters such as an image density parameter. The start key receives an instruction to start copying.

A user may sequentially switch a document box function, a copier function, a printer function, and a facsimile function of the image forming apparatus 10 one to another with an application switch key on the control panel 940 to select one of these functions of the image forming apparatus 10. When the document box function is selected, the image forming apparatus 10 enters a document box mode. When the copier function is selected, the image forming apparatus 10 enters a copier mode. When the printer function is selected, the image forming apparatus 10 enters a printer mode. When the facsimile function is selected, the image forming apparatus 10 enters a facsimile mode.

The network I/F 950 is an interface that enables data communication through a network. For example, the network I/F 950 enables communication in compliance with ETHERNET and Transmission Control Protocol (TCP)/Internet Protocol (IP). The network I/F 950 is electrically connected to the ASIC 906 through the PCI bus 922.

The hardware configuration of an information processing device of the image forming apparatus 10 is not limited to that illustrated in FIG. 2. The information processing device does not necessarily include all the components illustrated in FIG. 2 or may include some other components.

### Functional Configuration and Operation of Image Forming Apparatus

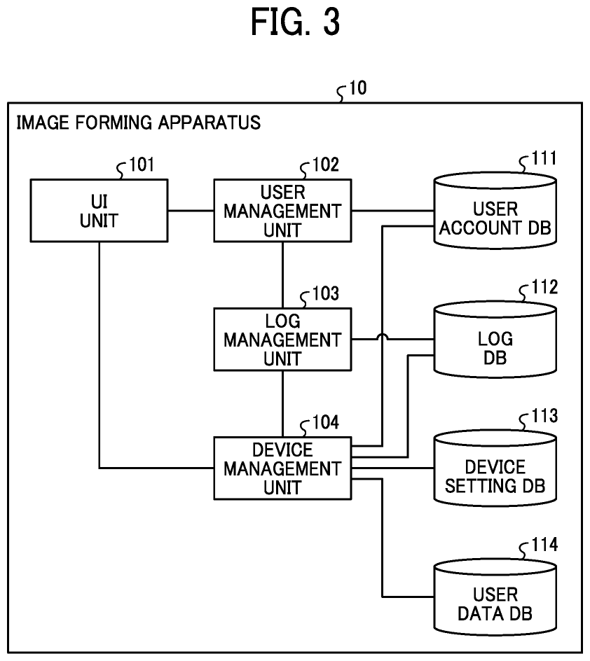

FIG. 3 is a block diagram illustrating a functional configuration of the image forming apparatus 10 according to the present embodiment.

Referring to FIG. 3, a description is given below of the functional configuration and operation of the image forming apparatus 10 according to the present embodiment.

As illustrated in FIG. 3, the image forming apparatus 10 includes a user interface (UI) unit 101 (interface unit), a user management unit 102 (a first management unit), a log management unit 103, a device management unit 104 (a second management unit), a user account database (DB) 111, a log DB 112, a device setting DB 113, and a user data DB 114.

The UI unit 101 is a functional unit that provides a user interface such as a screen for a user including an administrator to perform operations on the image forming apparatus 10. The operations on the image forming apparatus 10 include a special device management operation and other device management operations. The special device management operation is predetermined as an operation related to important content in terms of information security. The other device management operations may be referred to as typical device management operations in the following description. Examples of the special device management operation include, but are not limited to: viewing, changing (including deleting), and taking out user account information; viewing, changing (including deleting), and taking out a log; initializing the configuration of the image forming apparatus 10; viewing, changing (including deleting), and taking out user data; an operation to change an operation defined as the special device management operation to a typical device management operation; and an operation to change an operation defined as the typical device management operation to the special device management operation. One example of the typical device management operations is an operation to set the time for shifting to an energy saving mode.

The administrators are authorized to perform the special device management operation and the typical device management operations.

The user management unit 102 is a functional unit that performs various processes such as an authentication process for a user of the image forming apparatus 10.

The log management unit 103 is a functional unit that reads and writes a log, as a record of the image forming apparatus 10, from and into the log DB 112.

The device management unit 104 is a functional unit that manages the image forming apparatus 10 and executes a process corresponding to a device management operation performed by a user. Examples of the management of the image forming apparatus 10 include, but are not limited to, the setting of the image forming apparatus 10 and the maintenance of the image forming apparatus 10.

The user account DB 111 is a database that stores account information of users such as user IDs, passwords, and contact information.

The log DB 112 is a database that stores logs of operations performed on the image forming apparatus 10 and actions performed by the image forming apparatus 10.

The device setting DB 113 is a database that stores setting information of the image forming apparatus 10.

The user data DB 114 is a database that stores various data on which the user has caused the image forming apparatus 10 to perform processing. Examples of such data include, but are not limited to, digitized document data generated by the scanner controller 931 scanning a document, transmitted or received facsimile data, print data, information on business partners or customers.

The UI unit 101, the user management unit 102, the log management unit 103, and the device management unit 104 are implemented by, for example, the CPU 901 illustrated in FIG. 2 executing a program. At least a part of the UI unit 101, the user management unit 102, the log management unit 103, and the device management unit 104 may be implemented by a hardware circuit such as a field-programmable gate array (FPGA) or an ASIC.

The user account DB 111, the log DB 112, the device setting DB 113, and the user data DB 114 are implemented by the HD 909 illustrated in FIG. 2. At least a part of the user account DB 111, the log DB 112, the device setting DB 113, and the user data DB 114 may be implemented by an external storage device such as a cloud.

Each functional unit of the image forming apparatus 10 illustrated in FIG. 3 is a conceptual representation of a function. The functional configuration of the image forming apparatus 10 is not limited to that illustrated in FIG. 3. For example, a plurality of functional units of the image forming apparatus 10 illustrated as independent units in FIG. 3 may be configured as a single functional unit. By contrast, functions provided by a single functional unit of the image forming apparatus 10 illustrated in FIG. 3 may be divided and allocated to a plurality of functional units.

### Process for Enabling Special Device Management Operation

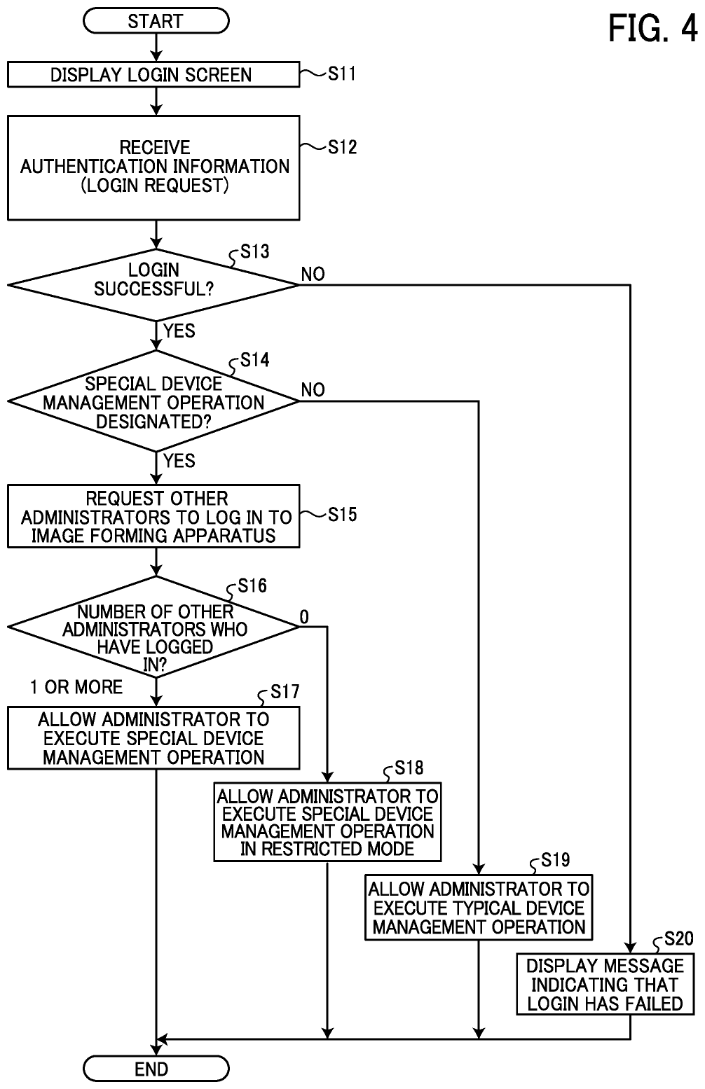

FIG. 4 is a flowchart of a process for enabling a special device management operation on the image forming apparatus 10 according to the present embodiment.

Referring to the flowchart of FIG. 4, a description is given below of the process for enabling the special device management operation on the image forming apparatus 10 according to the present embodiment.

In the following description, the administrator uses the information device 20a.

### Step S11

The administrator operates the information device 20a to cause the image forming apparatus 10 to display a login screen on the information device 20a. In response to the operation, the UI unit 101 of the image forming apparatus 10 causes the information device 20a to display the login screen. Then, the process proceeds to step S12.

### Step S12

The administrator inputs authentication information (for example, a username and a password) to the login screen displayed on the information device 20a to request login. In response, the information device 20a transmits a login request including the authentication information to the image forming apparatus 10. The UI unit 101 of the image forming apparatus 10 receives the login request transmitted from the information device 20a. Then, the process proceeds to step S13.

### Step S13

When the image forming apparatus 10 receives the login request, the user management unit 102 of the image forming apparatus 10 performs an authentication process based on the authentication information included in the login request. When the authentication process results in successful authentication, that is when the login is successful (YES in step S13), the process proceeds to step S14. By contrast, when the authentication process results in unsuccessful authentication, that is, when the login has failed (NO in step S13), the process proceeds to step S20.

### Step S14

After the login is successful, when the administrator designates a special device management operation through the information device 20a, that is, when the administrator inputs the designation of the special device management operation to the information device 20a and the UI unit 101 of the image forming apparatus 10 receives the designated value or command data (YES in step S14), the process proceeds to step S15. By contrast, when the administrator does not designate the special device management operation (No in step S14), the process proceeds to step S19. Alternatively, the administrator may designate the special device management operation in the login operation.

### Step S15

When the special device management operation is designated through the information device 20a, the user management unit 102 of the image forming apparatus 10 requests the information devices 20 used by other administrators to log in to the image forming apparatus 10. In this case, for example, the user management unit 102 refers to the user account DB 111 and requests login based on contact information (for example, mobile phone numbers, e-mail addresses, or facsimile numbers) registered in the account information of the other administrators. In this case, the user management unit 102 may request login by Short Message Service (SMS) when the contact information is a mobile phone number, by e-mail when the contact information is an e-mail address, or by facsimile transmission when the contact information is a facsimile number. Alternatively, for example, the user management unit 102 may request login through a social networking service (SNS). Then, the process proceeds to step S16.

### Step S16

When the number of other administrators who have logged in to the image forming apparatus 10 in response to the request for logging in is one or more (1 OR MORE in step S16), the process proceeds to step S17. By contrast, when the number of other administrators who have logged in is zero (0 in step S16), the process proceeds to step S18.

### Step S17

The image forming apparatus 10 allows the administrator to execute the special device management operation. Specifically, the UI unit 101 of the image forming apparatus 10 notifies the information device 20a of the administrator and the information devices 20 of the other administrators that the administrator performs the special device management operation and causes the information device 20a to display a screen for the special device management operation. Thus, the process for enabling the special device management operation on the image forming apparatus 10 is completed.

### Step S18

The image forming apparatus 10 allows the administrator to execute a predetermined device management operation in a restricted mode. Specifically, the UI unit 101 of the image forming apparatus 10 receives the special device management operation in the restricted mode. The restricted mode includes at least one of two modes: a mode in which only browsing of important content in terms of information security is allowed and neither changing (including deleting) nor taking out the important content is allowed, and a mode in which the administrator is forcibly logged out without notification to the UI unit 101 of the image forming apparatus 10 or the information device 20a after an elapse of a predetermined time. Thus, the process for enabling the special device management operation on the image forming apparatus 10 is completed. Alternatively, the administrator may be logged out after the notification is sent to the UI unit 101 of the image forming apparatus 10 or the information device 20a.

### Step S19

The image forming apparatus 10 allows the administrator to execute the typical device management operation.

Thus, the process for enabling the special device management operation on the image forming apparatus 10 is completed.

### Step S20

When the authentication is unsuccessful (i.e., login failure), the UI unit 101 of the image forming apparatus 10 causes the information device 20a to display a message indicating that the login has failed. Thus, the process for enabling the special device management operation on the image forming apparatus 10 is completed.

### Process for Executing Special Device Management Operation

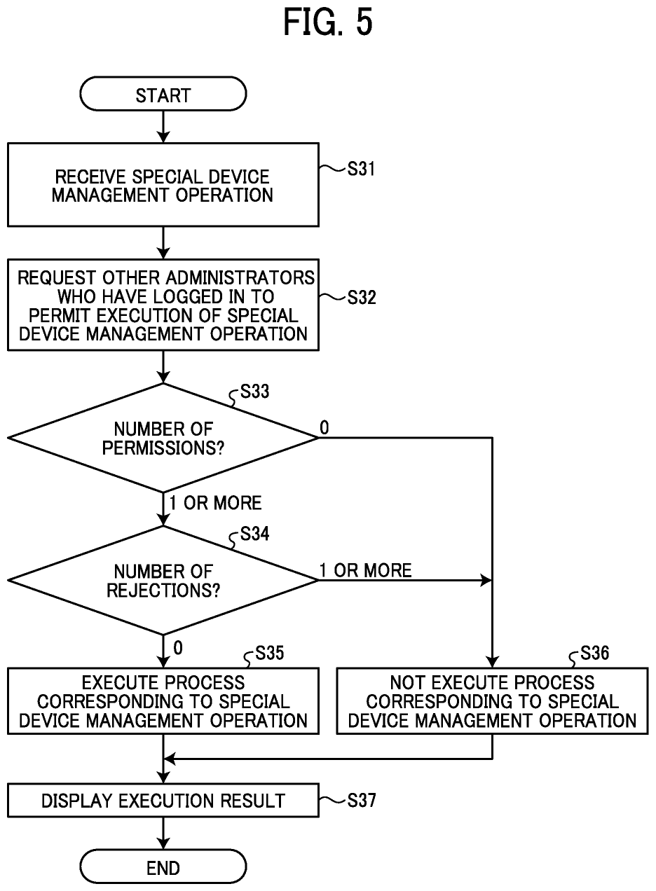

FIG. 5 is a flowchart of a process for executing a special device management operation on the image forming apparatus 10 according to the present embodiment.

Referring to the flowchart of FIG. 5, a description is given below of the process for executing the special device management operation on the image forming apparatus 10 according to the present embodiment.

In the following description, the administrator uses the information device 20a. At the start of the process illustrated in FIG. 5, one or more other administrators have logged in to the image forming apparatus 10, allowing the administrator to execute the special device management operation.

### Step S31

The administrator performs the special device management operation on the image forming apparatus 10 through the information device 20a. The UI unit 101 of the image forming apparatus 10 receives the special device management operation. Then, the process proceeds to step S32.

### Step S32

When the image forming apparatus 10 receives the special device management operation, the device management unit 104 of the image forming apparatus 10 requests the information devices 20 of the one or more other administrators who have logged in in response to the request in step S15 of FIG. 4 to permit the execution of the special device management operation. The one or more other administrators using the information devices 20 that have received the request permit or reject the execution of the special device management operation. Then, the process proceeds to step S33.

### Step S33

When the number of permissions (i.e., the number of other administrators who have permitted the execution of the special device management operation in response to the request from the image forming apparatus 10) is one or more (1 OR MORE in step S33), the process proceeds to step S34. By contrast, when the number of permissions is zero (0 in step S33), the process proceeds to step S36.

### Step S34

When the number of rejections (i.e., the number of other administrators who have rejected the execution of the special device management operation in response to the request from the image forming apparatus 10) is zero (0 in step S34), the process proceeds to step S35. By contrast, when the number of rejections is one or more (1 OR MORE in step S34), the process proceeds to step S36.

### Step S35

The device management unit 104 of the image forming apparatus 10 executes a process corresponding to a special device management operation. Then, the process proceeds to S37.

### Step S36

Since no other administrators permit the execution of the special device management operation, or since one or more other administrators have rejected the execution of the special device management operation, the image forming apparatus 10 does not execute the process corresponding to the special device management operation. Then, the process proceeds to S37.

### Step S37

The image forming apparatus 10 causes the information device 20a to display the result of execution of the process corresponding to the special device management operation or that the process corresponding to the special device management operation has not been executed. The image forming apparatus 10 may cause the information devices 20 of the other administrators to display the information.

Thus, the process for executing the special device management operation on the image forming apparatus 10 is completed.

### Details of Process for Enabling Special Device Management Operation

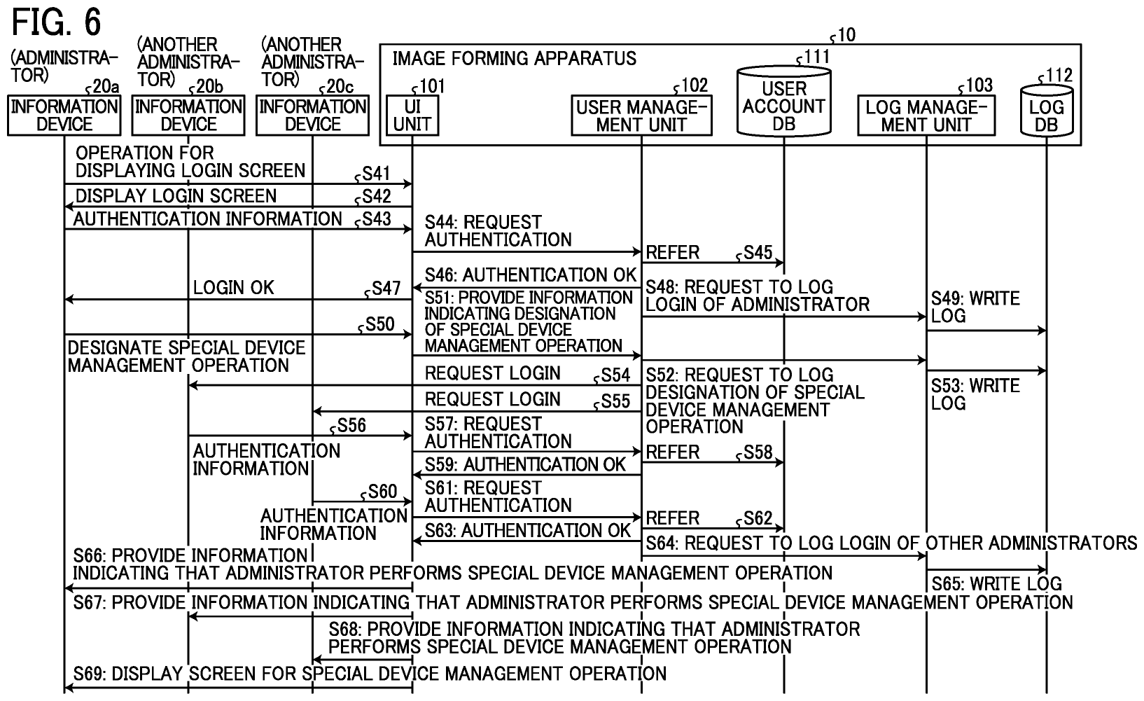

FIG. 6 is a sequence diagram illustrating a process for enabling a special device management operation on the image forming apparatus 10 according to the present embodiment.

Referring to FIG. 6, a detailed description is given below of the process for enabling the special device management operation on the image forming apparatus 10 according to the present embodiment.

In the following description, the administrator uses the information device 20a, whereas the other administrators use the information devices 20b and 20c.

### Step S41

The administrator operates the information device 20a to cause the image forming apparatus 10 to display a login screen on the information device 20a.

### Step S42

When the UI unit 101 of the image forming apparatus 10 receives the operation for displaying the login screen from the information device 20a, the UI unit 101 causes the information device 20a to display the login screen.

### Step S43

The administrator inputs authentication information (for example, a username and a password) to the login screen displayed on the information device 20a to request login. In response, the information device 20a transmits a login request including the authentication information to the image forming apparatus 10.

### Step S44

When the UI unit 101 receives the login request including the authentication information from the information device 20a, the UI unit 101 transmits an authentication request including the authentication information to the user management unit 102.

### Steps S45 and S46

The user management unit 102 refers to the user account DB 111 and compares the authentication information included in the authentication request received from the UI unit 101 with the account information stored in the user account DB 111 for authentication. When the user management unit 102 determines that the authentication is successful (OK), the user management unit 102 transmits the determination result to the UI unit 101.

### Step S47

The UI unit 101 notifies the information device 20a that the authentication is successful (login OK).

### Steps S48 and S49

The user management unit 102 requests the log management unit 103 to log the login of the administrator as a result of the authentication process. In response to the request, the log management unit 103 records (writes) the login of the administrator in the log DB 112.

### Step S50

The administrator who has logged in to the image forming apparatus 10 designates the special device management operation through the information device 20a. The designation of the special device management operation is a concept including the special device management operation itself.

### Step S51

When the UI unit 101 receives the designation of the special device management operation from the information device 20a, the UI unit 101 notifies the user management unit 102 of the designation.

### Steps S52 and S53

When the user management unit 102 receives the notification of the designation of the special device management operation, the user management unit 102 requests the log management unit 103 to log the designation of the special device management operation. In response to the request, the log management unit 103 records the designation of the special device management operation in the log DB 112.

### Steps S54 and S55

After receiving the notification of the designation of the special device management operation, the user management unit 102 requests the information devices 20b and 20c used by the other administrators to log in to the image forming apparatus 10. The user management unit 102 may change the time from when the user management unit 102 requests the information devices 20 of the other administrators to log in to the image forming apparatus 10 to when the other administrators perform a login operation. In the following description, the other administrators using the information devices 20b and 20c log in in response to the request.

### Step S56

The other administrator using the information device 20b inputs authentication information (for example, a username and a password) to a login screen displayed on the information device 20b to request loin. In response, the information device 20b transmits a login request including the authentication information to the image forming apparatus 10.

### Step S57

When the UI unit 101 receives the login request including the authentication information from the information device 20b, the UI unit 101 transmits an authentication request including the authentication information to the user management unit 102.

### Steps S58 and S59

The user management unit 102 refers to the user account DB 111 and compares the authentication information included in the authentication request received from the UI unit 101 with the account information stored in the user account DB 111 for authentication. When the user management unit 102 determines that the authentication is successful (OK), the user management unit 102 transmits the determination result to the UI unit 101.

### Step S60

The other administrator using the information device 20c inputs authentication information (for example, a username and a password) to a login screen displayed on the information device 20c to request loin. In response, the information device 20c transmits a login request including the authentication information to the image forming apparatus 10.

### Step S61

When the UI unit 101 receives the login request including the authentication information from the information device 20c, the UI unit 101 transmits an authentication request including the authentication information to the user management unit 102.

### Steps S62 and S63

The user management unit 102 refers to the user account DB 111 and compares the authentication information included in the authentication request received from the UI unit 101 with the account information stored in the user account DB 111 for authentication. When the user management unit 102 determines that the authentication is successful (OK), the user management unit 102 transmits the determination result to the UI unit 101.

### Steps S64 and S65

The user management unit 102 requests the log management unit 103 to log the login of the other administrators as a result of the authentication process related to the other administrators using the information devices 20b and 20c.

In response to the request, the log management unit 103 records the login of the other administrators in the log DB 112.

### Steps S66 to S68

The UI unit 101 notifies each of the information devices 20a to 20c that the administrator using the information device 20a is allowed to perform the special device management operation.

### Step S69

The UI unit 101 causes the information device 20a to display the screen for the special device management operation. At this time, the image forming apparatus 10 can be subjected to the execution of the special device management operation by the administrator using the information device 20a. Thus, the process for enabling the special device management operation on the image forming apparatus 10 is completed.

### Details of Process for Executing Special Device Management Operation

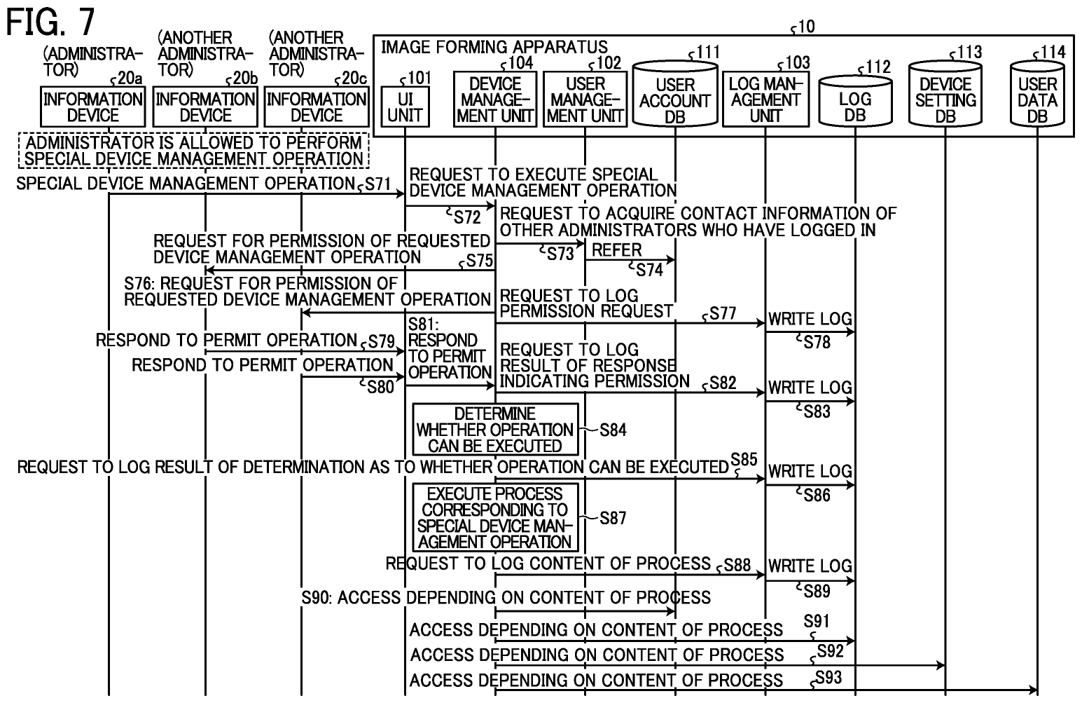

FIG. 7 is a sequence diagram illustrating a process for executing a special device management operation on the image forming apparatus 10 according to the embodiment.

Referring to FIG. 7, a detailed description is given below of the process for executing the special device management operation on the image forming apparatus 10 according to the present embodiment.

In the following description, the administrator uses the information device 20a, whereas the other administrators use the information devices 20b and 20c. At the start of the process illustrated in FIG. 7, the other administrators using the information devices 20b and 20c have logged in to the image forming apparatus 10, allowing the administrator using the information device 20a to execute the special device management operation.

### Step S71

The administrator performs the special device management operation on the image forming apparatus 10 through the information device 20a. When the administrator using the information device 20a is allowed to execute the special device management operation on the image forming apparatus 10 as a result of the process illustrated in FIG. 6, the administrator does not necessarily perform the special device management operation in this step and may cancel the special device management operation. In other words, after the administrator using the information device 20a is allowed to execute the special device management operation on the image forming apparatus 10, the administrator may select whether to execute the special device management operation. In this case, the UI unit 101 may receive the special device management operation or the cancellation of the special device management operation from the administrator through the information device 20a. When the designation of the special device management operation in step S50 illustrated in FIG. 6 is the special device management operation itself, step S71 may be skipped.

### Step S72

When the UI unit 101 receives the special device management operation from the information device 20a, the UI unit 101 transmits a request to execute the special device management operation to the device management unit 104.

### Steps S73 and S74

When the device management unit 104 receives the request to execute the special device management operation, the device management unit 104 transmits, to the user management unit 102, a request to acquire the contact information of the other administrators who have logged in. In response to the request, the user management unit 102 refers to the user account DB 111, acquires the contact information of the other administrators who have logged in from the account information, and transmits the acquired contact information to the device management unit 104.

### Steps S75 and S76

The device management unit 104 requests the information devices 20b and 20c of the other administrators who have logged in to permit the execution of the special device management operation, based on the contact information received from the user management unit 102. The device management unit 104 may change the time from when the device management unit 104 requests the information devices 20 of the other administrators to permit the execution of the special device management operation to when the other administrators respond to the request. In the following description, the other administrators using the information devices 20b and 20c permit the execution of the special device management operation in response to the request.

### Steps S77 and S78

The device management unit 104 requests the log management unit 103 to log that the information devices 20b and 20c have been requested to permit the execution of the special device management operation. In response to the request, the log management unit 103 records, in the log DB 112, that the information devices 20b and 20c have been requested to permit the execution of the special device management operation.

### Steps S79 and S80

The other administrators operate the respective information devices 20b and 20c to respond to permit the execution of the special device management operation. In response to the operation, each of the information devices 20b and 20c transmits a response to permit the execution of the special device management operation to the image forming apparatus 10.

### Step S81

When the UI unit 101 receives the response to permit the execution of the special device management operation from each of the information devices 20b and 20c, the UI unit 101 transmits the response of permission to the device management unit 104.

### Steps S82 and S83

The device management unit 104 requests the log management unit 103 to log the result of response from the information devices 20b and 20c indicating that the execution of the special device management operation is permitted. In response to the request, the log management unit 103 records the result of response indicating permission in the log DB 112.

### Step S84

The device management unit 104 determines whether the special device management operation can be executed, based on the response of permission or rejection of the execution of the special device management operation from the information devices 20b and 20c. Specifically, the device management unit 104 performs the determination of steps S33 and S34 illustrated in FIG. 5. In this case, since the device management unit 104 has received the response of permission of the execution of the special device management operation from the information devices 20b and 20c, the device management unit 104 determines that the administrator can execute the special device management operation.

### Steps S85 and S86

The device management unit 104 requests the log management unit 103 to log the result of determination as to whether the administrator can execute the special device management operation. In response to the request, the log management unit 103 records the determination result in the log DB 112.

### Step S87

The device management unit 104 executes a process corresponding to the special device management operation.

### Steps S88 and S89

The device management unit 104 requests the log management unit 103 to log the content of the executed process corresponding to the special device management operation. In response to the request, the log management unit 103 records the content of the process in the log DB 112.

### Steps S90 to S93

When executing the process corresponding to the special device management operation, the device management unit 104 accesses the user account DB 111, the log DB 112, the device setting DB 113, or the user data DB 114 as appropriate for the content of the process. The UI unit 101 causes the information device 20a to display the result of the process corresponding to the special device management operation executed by the device management unit 104. The UI unit 101 may also cause the information devices 20 of the other administrators to display the result. Thus, the process for executing the special device management operation on the image forming apparatus 10 is completed.

### Details of Process for Executing Typical Device Management Operation

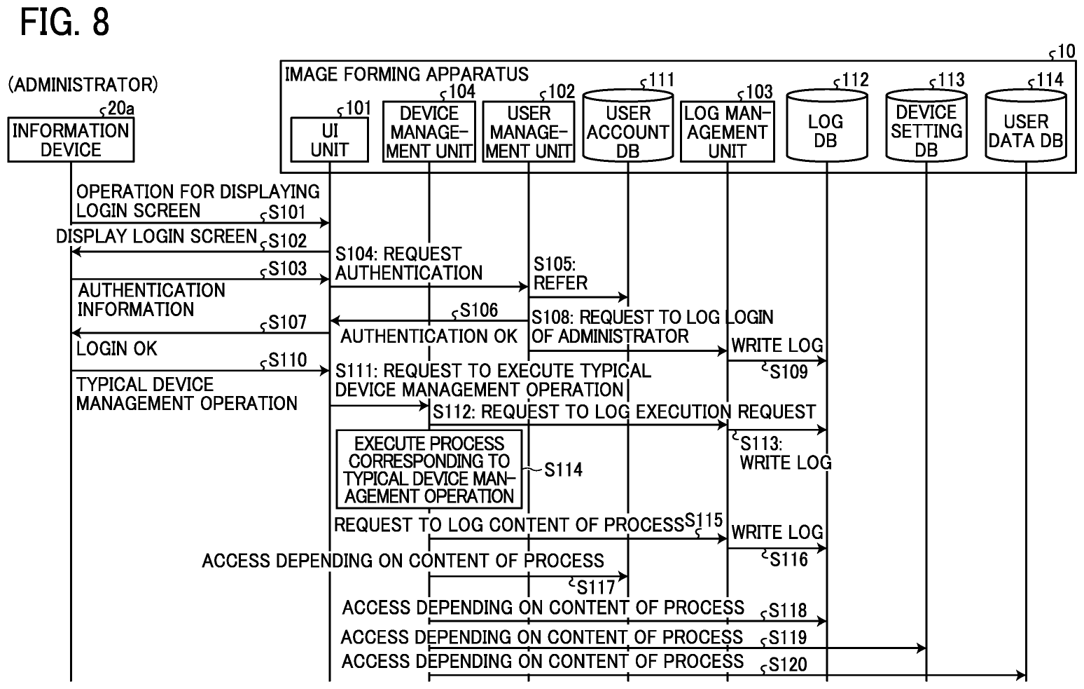

FIG. 8 is a sequence diagram illustrating a process for executing a typical device management operation on the image forming apparatus 10 according to the embodiment.

Referring to FIG. 8, a detailed description is given below of the process for executing the typical device management operation on the image forming apparatus 10 according to the present embodiment.

In the following description, the administrator uses the information device 20a.

### Steps S101 to S109

The actions of steps S101 to S109 are substantially the same as the actions of steps S41 to S49 illustrated in FIG. 6, respectively.

### Step S110

The administrator who has logged in to the image forming apparatus 10 performs the typical device management operation on the image forming apparatus 10 through the information device 20a.

### Step S111

When the UI unit 101 receives the typical device management operation from the information device 20a, the UI unit 101 transmits a request to execute the typical device management operation to the device management unit 104.

### Steps S112 and S113

The device management unit 104 requests the log management unit 103 to log the request for execution of the typical device management operation from the information device 20a. In response to the request, the log management unit 103 records, in the log DB 112, the request for execution of the typical device management operation from the information device 20a.

### Step S114

The device management unit 104 executes a process corresponding to the typical device management operation.

### Step S115 and S116

The device management unit 104 requests the log management unit 103 to log the content of the executed process corresponding to the typical device management operation. In response to the request, the log management unit 103 records the content of the process in the log DB 112.

### Steps S117 to S120

When executing the process corresponding to the typical device management operation, the device management unit 104 accesses the user account DB 111, the log DB 112, the device setting DB 113, or the user data DB 114 as appropriate for the content of the process. The UI unit 101 may cause the information device 20a to display the result of the process corresponding to the typical device management operation executed by the device management unit 104. Thus, the process for executing the typical device management operation on the image forming apparatus 10 is completed.

As described above, for the execution of the process corresponding to the typical device management operation, the other administrators do not need to log in to the image forming apparatus 10 or permit the execution.

As described above, in the image forming apparatus 10 according to the present embodiment, the user management unit 102 performs the authentication process in response to a request from the information device 20a of the administrator to log in to the image forming apparatus 10. When the administrator logs in based on the authentication process performed by the user management unit 102, the UI unit 101 receives the designation of the special device management operation, which is predetermined as an operation related to important content in terms of information security, from the administrator through the information device 20a. When the UI unit 101 receives the designation of the special device management operation, the user management unit 102 requests the information device 20 of each of one or more other administrators different from the administrator to log in to the image forming apparatus 10. When one or more other administrators log in, the UI unit 101 receives the special device management operation from the administrator through the information device 20a. When the UI unit 101 receives the special device management operation, the device management unit 104 requests the information device 20 of each of the one or more administrators who have logged in to the image forming apparatus 10 to permit the execution of the special device management operation. When one or more other administrators permit the execution of the special device management operation and no other administrator rejects the execution of the special device management operation, the device management unit 104 executes the process corresponding to the special device management operation. Such a configuration prevents unfavorable situations such as change, deletion, leakage or erroneous transmission of the important information in an undesirable response or a forced response (for example, a response due to misunderstanding or misrecognition caused by a mental disease, or a response forced by a third party).

The administrator who uses the information device 20a, the information device 20a, the other administrators, and the information devices 20, 20b, and 20c used by the other administrators described with reference to FIGS. 4 to 8 serve as a “first administrator,” a “first information terminal,” “second administrators,” and “second information terminals,” respectively, according to one or more embodiments of the present disclosure.

In the embodiments described above, when at least one of the functional units of the image forming apparatus 10 is implemented by execution of a program, the program is prestored in, for example, a ROM and provided. Alternatively, in the embodiments described above, the program that is executed by the image forming apparatus 10 may be stored in a computer-readable recording medium in an installable or executable file format so that the program can be provided. Examples of the computer-readable recording medium include, but are not limited to, a CD-ROM, a flexible disk (FD), a CD-R, and a DVD. Alternatively, in the embodiments described above, the program that is executed by the image forming apparatus 10 may be stored on a computer connected to a network such as the Internet so that the program can be downloaded through the network and provided. Alternatively, in the embodiments described above, the program that is executed by the image forming apparatus 10 may be provided or distributed through a network such as the Internet. In the embodiments described above, the program that is executed by the image forming apparatus 10 has a module structure including at least one of the functional units described above. Regarding the actual hardware related to the program, the CPU 901 reads the program from the storage device described above (for example, the MEM-P 902, the MEM-C 907, or the HD 909) and executes the program to load the functional units described above onto the main memory and implement the functional units.

A description is given below of some aspects of the present disclosure.

According to a first aspect, an image forming apparatus includes a first management unit, an interface unit, and a second management unit. The first management unit performs an authentication process in response to a request from a first information terminal of a first administrator to log in to the image forming apparatus. When the first administrator logs in based on the authentication process performed by the first management unit, the interface unit receives the designation of a device management operation, which is predetermined as an operation related to important content in terms of information security, from the first administrator through the first information terminal. When the interface unit receives the designation of the device management operation, the first management unit transmits a request to log in to the image forming apparatus, to second information terminals of one or more second administrators different from the first administrator. When at least one second administrator logs in, the interface unit receives the device management operation from the first administrator through the first information terminal. When the interface unit receives the device management operation, a second management unit transmits a request to permit execution of the device management operation to the second information terminal of the at least one second administrator who has logged in to the image forming apparatus. When at least one of the at least one second administrator permits the execution of the device management operation and no one of the at least one second administrator rejects the execution of the device management operation, the second management unit executes a process corresponding to the device management operation.

According to a second aspect, in the image forming apparatus of the first aspect, the interface unit receives the predetermined device management operation in a restricted mode when no one of the one or more second administrators logs in to the image forming apparatus in response to the request from the first management unit.

According to a third aspect, in the image forming apparatus of the second aspect, the restricted mode includes at least one of two modes: a mode in which only browsing of important content in terms of information security is allowed and a mode in which the first administrator is forcibly logged out after an elapse of a predetermined time.

According to a fourth aspect, in the image forming apparatus according to any one of the first to third aspects, the first management unit can change a time from when the first management unit transmits the request to log in to the image forming apparatus to the second information terminals of the one or more second administrators to when the at least one second administrator performs a login operation through the second information terminal.

According to a fifth aspect, in the image forming apparatus of any one of the first to fourth aspects, the second management unit can change a time from when the second management unit transmits the request to permit the execution of the device management operation to the second information terminal of the at least one second administrator to when the at least one second administrator responds to the request to permit through the second information terminal.

According to a sixth aspect, in the image forming apparatus of any one of the first to fifth aspects, the interface unit receives the device management operation or cancellation of the device management operation from the first administrator through the first information terminal when the at least one second administrator logs in.

According to a seventh aspect, in the image forming apparatus of any one of the first to sixth aspects, the device management operation includes: an operation to change the device management operation to another device management operation, and an operation to change the other device management operation to the device management operation.

According to an eighth aspect, an information processing method for an image forming apparatus includes an authenticating step, a first receiving step, a first requesting step, a second receiving step, a second requesting step, and an executing step. In the authenticating step, a first management unit performs an authentication process in response to a request from a first information terminal of a first administrator to log in to the image forming apparatus. In the first receiving step, an interface unit receives the designation of a device management operation, which is predetermined as an operation related to important content in terms of information security, from the first administrator through the first information terminal when the first administrator logs in based on the authentication process performed by the first management unit. In the first requesting step, the first management unit transmits a request to log in to the image forming apparatus, to second information terminals of one or more second administrators different from the first administrator, when the interface unit receives the designation of the device management operation. In the second receiving step, the interface unit receives the device management operation from the first administrator through the first information terminal when at least one second administrator logs in. In the second requesting step, a second management unit transmits a request to permit execution of the device management operation to the second information terminal of the at least one second administrator who has logged in to the image forming apparatus, when the interface unit receives the device management operation. In the executing step, the second management unit executes a process corresponding to the device management operation when at least one of the at least one second administrator permits the execution of the device management operation and no one of the at least one second administrator rejects the execution of the device management operation.

According to a ninth aspect, An information processing system includes an image forming apparatus, a first information terminal used by a first administrator, and second information terminals used by one or more second administrators different from the first administrator. The image forming apparatus includes a first management unit, an interface unit, and a second management unit. The first management unit performs an authentication process in response to a request from the first information terminal of the first administrator to log in to the image forming apparatus. When the first administrator logs in based on the authentication process performed by the first management unit, the interface unit receives the designation of a device management operation, which is predetermined as an operation related to important content in terms of information security, from the first administrator through the first information terminal. When the interface unit receives the designation of the device management operation, the first management unit transmits a request to log in to the image forming apparatus, to the second information terminals of the one or more second administrators. When at least one second administrator logs in, the interface unit receives the device management operation from the first administrator through the first information terminal. When the interface unit receives the device management operation, a second management unit transmits a request to permit execution of the device management operation to the second information terminal of the at least one second administrator who has logged in to the image forming apparatus. When at least one of the at least one second administrator permits the execution of the device management operation and no one of the at least one second administrator rejects the execution of the device management operation, the second management unit executes a process corresponding to the device management operation.

According to one or more aspects of the present disclosure, specific information, such as important information in terms of security, is prevented from being changed, deleted, leaked or erroneously transmitted.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image forming apparatus, comprising circuitry configured to:
perform an authentication process in response to a request from a first information terminal of a first administrator to log in to the image forming apparatus;
receive designation of a device management operation from the first administrator through the first information terminal when the first administrator logs in based on the authentication process;
transmit a request to log in to the image forming apparatus, to second information terminals of one or more second administrators different from the first administrator, in response to the designation of the device management operation;
receive the device management operation from the first administrator through the first information terminal when at least one second administrator logs in;
transmit a request to permit execution of the device management operation to the second information terminal of the at least one second administrator who has logged in to the image forming apparatus, in response to the device management operation; and
execute a process corresponding to the device management operation when at least one of the at least one second administrator permits the execution of the device management operation and no one of the at least one second administrator rejects the execution of the device management operation.

2. The image forming apparatus according to claim 1,
wherein the circuitry is configured to receive the device management operation in a restricted mode when no one of the one or more second administrators logs in to the image forming apparatus in response to the request to log in.

3. The image forming apparatus according to claim 2,
wherein the restricted mode includes at least one of a mode in which only browsing is allowed or a mode in which the first administrator is logged out after an elapse of a predetermined time.

4. The image forming apparatus according to claim 1,
wherein the circuitry is configured to change a time from when the circuitry transmits the request to log in to when the at least one second administrator performs a login operation through the second information terminal.

5. The image forming apparatus according to claim 1,
wherein the circuitry is configured to change a time from when the circuitry transmits the request to permit the execution of the device management operation to when the at least one second administrator responds to the request to permit through the second information terminal.

6. The image forming apparatus according to claim 1,
wherein the circuitry is configured to receive the device management operation or cancellation of the device management operation from the first administrator through the first information terminal when the at least one second administrator logs in.

7. The image forming apparatus according to claim 1,
wherein the device management operation includes:
an operation to change the device management operation to another device management operation; and
an operation to change the other device management operation to the device management operation.

8. An information processing method performed by an image forming apparatus, the method comprising:
performing an authentication process in response to a request from a first information terminal of a first administrator to log in to the image forming apparatus;
receiving designation of a device management operation from the first administrator through the first information terminal when the first administrator logs in based on the authentication process;
transmitting a request to log in to the image forming apparatus, to second information terminals of one or more second administrators different from the first administrator, in response to the designation of the device management operation;
receiving the device management operation from the first administrator through the first information terminal when at least one second administrator logs in;
transmitting a request to permit execution of the device management operation to the second information terminal of the at least one second administrator who has logged in to the image forming apparatus, in response to the device management operation; and
executing a process corresponding to the device management operation when at least one of the at least one second administrator permits the execution of the device management operation and no one of the at least one second administrator rejects the execution of the device management operation.

9. An information processing system comprising:
an image forming apparatus;
a first information terminal used by a first administrator; and
second information terminals used by one or more second administrators different from the first administrator,
the image forming apparatus including circuitry configured to:
perform an authentication process in response to a request from the first information terminal of the first administrator to log in to the image forming apparatus;
receive designation of a device management operation from the first administrator through the first information terminal when the first administrator logs in based on the authentication process;
transmit a request to log in to the image forming apparatus, to the second information terminals of the one or more second administrators, in response to the designation of the device management operation;
receive the device management operation from the first administrator through the first information terminal when at least one second administrator logs in;
transmit a request to permit execution of the device management operation to the second information terminal of the at least one second administrator who has logged in to the image forming apparatus, in response to the device management operation; and
execute a process corresponding to the device management operation when at least one of the at least one second administrator permits the execution of the device management operation and no one of the at least one second administrator rejects the execution of the device management operation.
